(19) United States
(12) Patent Application Publication
(10) Pub. No.: US 2019/0393585 A1
(43) Pub. Date: Dec. 26, 2019

(54) TRANSPARENT CONDUCTIVE FILM FOR ANTENNAS

(71) Applicant: TDK CORPORATION, Tokyo (JP)

(72) Inventors: Yoshihisa TAMAGAWA, Tokyo (JP); Hiroshi SHINGAI, Tokyo (JP); Kazuhisa INABA, Tokyo (JP); Syunji MATSUBARA, Tokyo (JP)

(73) Assignee: TDK CORPORATION, Tokyo (JP)

(21) Appl. No.: 16/480,957

(22) PCT Filed: Jan. 22, 2018
(86) PCT No.: PCT/JP2018/001775

§ 371 Date: Jul. 25, 2019

(30) Foreign Application Priority Data
Jan. 25, 2017 (JP) 2017-011362

(51) Int. Cl. H01Q 1/22; B32B 17/10; H01Q 1/38

(52) U.S. Cl. CPC H01Q 1/2283; H01Q 1/38; B32B 17/10174; B32B 17/10036

(57) ABSTRACT

A transparent conductive film for antennas, includes: a transparent resin substrate; a first metal oxide layer; a metal layer containing silver or a silver alloy; and a second metal oxide layer, stacked in this order.

### TECHNICAL FIELD

The present disclosure relates to a transparent conductive film for antennas.

### BACKGROUND ART

Antennas are required to efficiently send high-frequency electromagnetic waves through a space and efficiently receive those propagating through a space. Materials for antennas need to be highly conductive, and hence metal foils of copper or the like are conventionally used. Meanwhile, antennas are recently set in various places as outdoor and indoor network communications become widely used. In such circumstances, antennas with high transparency so as not to spoil the view of a place of setting are now under development.

For example, Patent Literature 1 proposes a technique of providing an antenna pattern formed of a conductor mesh layer on a transparent substrate to increase transparency of antennas.

### CITATION LIST

### Patent Literature

Patent Literature 1: Japanese Unexamined Patent Publication No. 2011-66610

### SUMMARY OF INVENTION

### Technical Problem

When a metal foil of copper or the like is used as a material for antennas, it is difficult to ensure sufficient transparency and flexibility. If a metal mesh is used to ensure transparency and flexibility, on the other hand, unevenness is likely to be generated in the surface of an antenna. In this case, application of a transparent resin coating material or the like to the surface possibly reduces such unevenness; however, the antenna performance is expected to be deteriorated.

For this reason, a material for antennas has been demanded which can achieve superior transparency and superior antenna performance in combination. In view of this, an object of the present invention is to provide a transparent conductive film for antennas which enables formation of antennas having superior transparency and superior antenna performance in combination.

### Solution to Problem

In one aspect, the present disclosure provides a transparent conductive film for antennas, the transparent conductive film comprising: a transparent resin substrate; a first metal oxide layer; a metal layer containing silver or a silver alloy; and a second metal oxide layer, stacked in this order.

The transparent conductive film has transparency, and is superior in flexibility because of its form of a film. In addition, the surface resistivity can be sufficiently reduced because of the inclusion of the metal layer containing silver or a silver alloy between the first metal oxide layer and the second metal oxide layer. Accordingly, the transparent conductive film enables formation of antennas having superior transparency and superior antenna performance in combination.

The total light transmittance of the transparent conductive film may be, for example, 50% or higher. Thereby, antennas having even higher transparency can be formed.

The surface resistivity of the transparent conductive film may be, for example, 20 Ω/sq. or lower, or 8 Ω/sq. or lower. Thereby, the antenna performance can be further enhanced. In addition, a transparent conductive film with low surface resistivity can be provided.

In an antenna fabricated from the transparent conductive film, a VSRW may be, for example, 2.0 or lower when the element length thereof is set to 30 mm.

The thicknesses of the first metal oxide layer and the second metal oxide layer in the transparent conductive film may be each 20 to 60 nm, and the thickness of the metal layer may be 5 to 30 nm. Thereby, the transparency and flexibility can be further increased with the surface resistivity sufficiently reduced.

At least the metal layer and the second metal oxide layer in the transparent conductive film may be etched with an acidic etching solution. Thereby, a transparent conductive film can be formed which is readily processed into a shape according to properties required for antennas such as antenna gain and directivity.

The thickness of the first metal oxide layer may be 24 to 50 nm. Thereby, the surface resistivity can be sufficiently reduced with the total light transmittance kept high. If such a transparent conductive film is used for an antenna, the antenna performance can be further enhanced.

### Advantageous Effects of Invention

In one aspect, the present disclosure can provide a transparent conductive film for antennas which enables formation of antennas having transparency and antenna performance in combination. In another aspect, the present disclosure can provide a transparent conductive film capable of sufficiently reducing the surface resistivity with the total light transmittance kept high.

### BRIEF DESCRIPTION OF DRAWINGS

FIG. 1 shows an elevation view of an antenna.

FIG. 2 shows a plan view of an antenna.

FIG. 3 shows a schematic cross-sectional view illustrating an embodiment of the transparent conductive film for an element of an antenna.

FIG. 4 shows a schematic cross-sectional view illustrating an embodiment of the transparent conductive film for a ground section of an antenna.

FIG. 5 shows a schematic cross-sectional view illustrating another embodiment of the transparent conductive film for an element of an antenna.

FIG. 6 shows a graph of relative radiation efficiency for Example 1 and Comparative Example 1.

FIG. 7 shows a graph of relation between the thickness of the metal layer and the surface resistivity.

FIG. 8 shows a graph of relation between the thickness of the first metal oxide layer, and the surface resistivity and the total light transmittance.

### DESCRIPTION OF EMBODIMENTS

Hereinafter, embodiments of the present invention will be described occasionally with reference to the drawings. However, the embodiments below are examples to describe the present invention, and are not intended to limit the present invention to the contents below. In explanation, identical structures or elements having identical function are provided with an identical reference sign, and redundant description is occasionally omitted. Positional relationship such as up and down and left and right is to be based on that shown in each drawing, unless otherwise stated. In addition, dimensional ratios of elements are not limited to those illustrated.

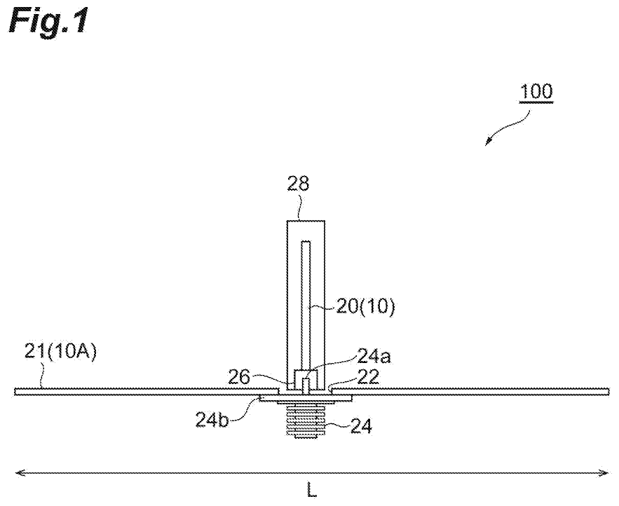

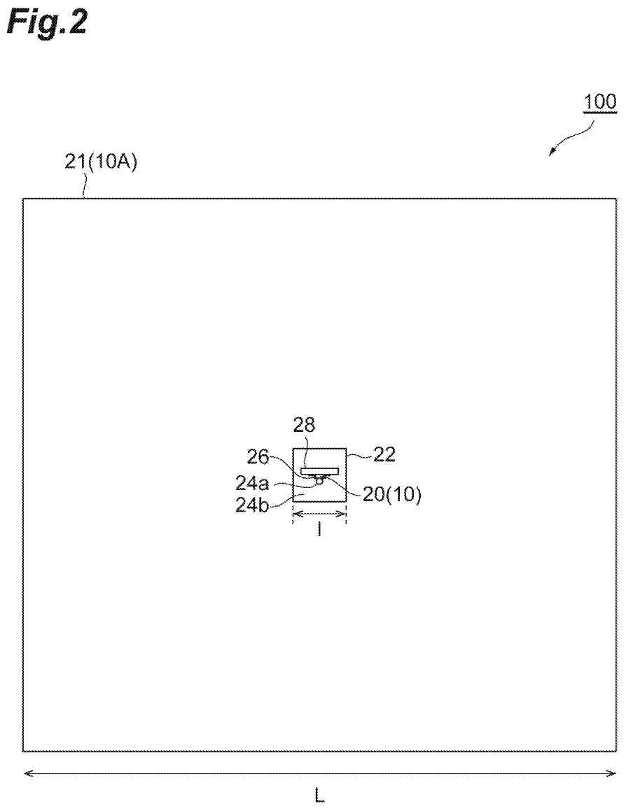

FIG. 1 shows an elevation view of an example of an antenna for which the transparent conductive film of the present embodiment is used. FIG. 2 shows a plan view of the antenna in FIG. 1. An antenna 100 is a monopole antenna, and includes an element 20, a supporting substrate 28 supporting the element 20, and a ground section 21. The external shape of the ground section 21 is a rectangle, and a rectangular through-hole 22 is formed at the center portion. To the through-hole 22, a connector 24 including a supporting section 24b in the form of a disk and a center pin 24a protruding upward from the supporting section 24b is attached. The supporting section 24b plugs the through-hole 22 from the lower side, and the center pin 24a is inserted through the through-hole 22.

The element 20 is disposed together with the supporting substrate 28 above the through-hole 22, and fixed to the center pin 24a with a paste 26. Thus, the element 20 and supporting substrate 28 and the supporting section 24b of the connector 24 are disposed to hold the ground section 21 therebetween. The paste 26 is, for example, a silver paste having conductivity. To the connector 24, for example, a cable (not shown) to transmit signals is connected.

The element 20 and the ground section 21 are composed of a transparent conductive film 10 and a transparent conductive film 10A, respectively. The structure and material of the transparent conductive film for the element 20 and those of the transparent conductive film for the ground section 21 may be the same as or different from each other.

The element length of the antenna 100 is the height of the upper end of the element 20 from the top surface of the ground section 21. The element length may be, for example, 10 to 50 mm. The element length can be appropriately adjusted according to frequency (wavelength) for application. The bandwidth is, for example, 1400 to 2200 MHz. It is preferable that the transparent conductive film 10 constituting the element 20 provide the antenna 100 with a VSWR (Voltage Standarding Wave Ratio) of 2.0 or lower when the element length is set to 30 mm, and it is more preferable that the transparent conductive film 10 constituting the element 20 provide the antenna 100 with a VSWR of 1.5 or lower when the element length is set to 30 mm. The VSWR can be measured by using a commercially available network analyzer.

The antenna 100 has superior radiation efficiency. The relative radiation efficiency to the radiation efficiency of an antenna using copper instead of the transparent conductive films 10 and 10A can be, for example, 0.5 or higher (50% or higher) at maximum.

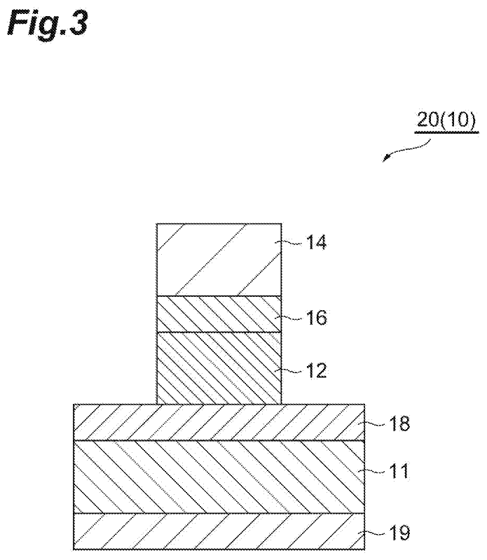

FIG. 3 shows a schematic cross-sectional view of the transparent conductive film 10 for antennas constituting the element 20. The direction of stacking in the transparent conductive film 10 corresponds to the depth direction in FIG. 1, and to the vertical direction in FIG. 2. The transparent conductive film 10 has a stacking structure including a transparent resin substrate 11 in the form of a film, a first metal oxide layer 12, a metal layer 16, and a second metal oxide layer 14, stacked in this order.

The transparent conductive film 10 further includes a pair of hard coat layers 18 and 19 (hereinafter, referred to as “first hard coat layer 18” and “second hard coat layer 19”, respectively) sandwiching the transparent resin substrate 11. Thus, the transparent conductive film 10 has a stacking structure including the second hard coat layer 19, the transparent resin substrate 11, the first hard coat layer 18, the first metal oxide layer 12, the metal layer 16, and the second metal oxide layer 14, stacked in this order. The transparent conductive film 10 in the antenna 100 in FIGS. 1 and 2 is disposed in a manner such that the second hard coat layer 19 and the supporting substrate 28 contact with each other.

The term “transparent” herein means that visible light is allowed to pass through, and scattering of light is acceptable to some extent. What allows scattering of light, such as what is generally called translucent, is also encompassed in the concept of “transparent” herein. It is preferable that the degree of light scattering be lower, and it is preferable that the transparency be higher. The total light transmittance of the transparent conductive film 10 is, for example, 50% or higher, preferably 60% or higher, more preferably 80% or higher, and particularly preferably 85% or higher. The total light transmittance is a transmittance determined by using an integrating sphere for light including diffuse transmitted light, and measured by using a commercially available haze meter. The haze measured by using a commercially available haze meter is, for example, lower than 1%.

The transparent resin substrate 11 is not limited, and may be an organic resin film having flexibility. The organic resin film may be an organic resin sheet. Examples of the organic resin film include polyester films such as polyethylene terephthalate (PET) and polyethylene naphthalate (PEN) films, polyolefin films such as polyethylene and polypropylene films, polycarbonate films, acrylic films, norbornene films, polyarylate films, polyether sulfone films, diacetyl cellulose films, and triacetyl cellulose films. Among these, polyester films such as polyethylene terephthalate (PET) and polyethylene naphthalate (PEN) films are preferable.

It is preferable from the viewpoint of rigidity that the transparent resin substrate 11 be thick. On the other hand, it is preferable from the viewpoint of thinning of the transparent conductive film 10 that the transparent resin substrate 11 be thin. From these viewpoints, the thickness of the transparent resin substrate 11 is, for example, 10 to 200 μm.

The transparent resin substrate 11 may have been subjected to at least one surface treatment selected from the group consisting of corona discharge treatment, glow discharge treatment, flame treatment, ultraviolet irradiation treatment, electron beam irradiation treatment, and ozone treatment. The transparent resin substrate 11 may be a resin film. Use of a resin film can impart superior flexibility to the transparent conductive film 10. This allows the transparent conductive film 10 to conform to various antenna shapes.

The second metal oxide layer 14 is a transparent layer containing an oxide, and, for example, contains zinc oxide as a primary component. The second metal oxide layer 14 may contain tin oxide as a sub-component, and may further contain indium oxide and titanium oxide. Inclusion of the four components of zinc oxide, tin oxide, indium oxide, and titanium oxide allows the second metal oxide layer 14 to have sufficiently high conductivity and high transparency in combination. Low surface resistivity can be achieved by including such a second metal oxide layer 14 and the metal layer 16 in combination. The zinc oxide is, for example, ZnO, and the tin oxide is, for example, SnO₂. The indium oxide is, for example, In₂O₃, and the titanium oxide is, for example, TiO₂. The ratio between metal atoms and oxygen atoms in each of the metal oxides may deviate from the stoichiometric ratio.

It is preferable that the ZnO content of the second metal oxide layer 14 to the total of the four components as the four components are converted to ZnO, SnO₂, In₂O₃, and TiO₂ be the highest among the contents of the four components. From the viewpoint of sufficiently increasing the total light transmittance and conductivity, the ZnO content to the total of the four components is, for example, 20 mol % or higher. From the viewpoint of sufficiently increasing the corrosion resistance, the ZnO content to the total of the four components is, for example, 65 mol % or lower.

From the viewpoint of sufficiently increasing the total light transmittance, the SnO₂ content of the second metal oxide layer 14 to the total of the four components is, for example, 40 mol % or lower. From the viewpoint of sufficiently reducing the surface resistivity, the SnO₂ content of the second metal oxide layer 14 to the total of the four components is, for example, 15 mol % or higher.

From the viewpoint of sufficiently reducing the surface resistivity and sufficiently increasing the total light transmittance, the In₂O₃ content of the second metal oxide layer 14 to the total of the four components is, for example, 35 mol % or lower. From the viewpoint of sufficiently increasing the corrosion resistance, the In₂O₃ content of the second metal oxide layer 14 to the total of the four components is, for example, 15 mol % or higher.

From the viewpoint of sufficiently increasing the total light transmittance, the TiO₂ content of the second metal oxide layer 14 to the total of the four components is, for example, 20 mol % or lower. From the viewpoint of sufficiently increasing the corrosion resistance, the TiO₂ content of the second metal oxide layer 14 to the total of the four components is, for example, 5 mol % or higher.

The second metal oxide layer 14 has functions of adjusting optical properties, protecting the metal layer 16, and ensuring conductivity in combination. The second metal oxide layer 14 may contain another sub-component unless the sub-component largely impairs the functions.

The first metal oxide layer 12 and the second metal oxide layer 14 may be the same as or different from each other in terms of thickness, structure, and composition. The resistance of the first metal oxide layer 12 and that of the second metal oxide layer 14 to etching solution can be altered by individually adjusting the compositions of the first metal oxide layer 12 and the second metal oxide layer 14. For example, only the second metal oxide layer 14 and the metal layer 16 can be removed by etching with an acidic etching solution to leave the first metal oxide layer 12 as it is.

The first metal oxide layer 12 is a transparent layer containing an oxide, and, for example, contains zinc oxide as a primary component. Similarly to the second metal oxide layer 14, the first metal oxide layer 12 may contain tin oxide, indium oxide, and titanium oxide as sub-components. Inclusion of the four components allows the first metal oxide layer 12 to have sufficiently high conductivity and high transparency in combination. The zinc oxide is, for example, ZnO, and the indium oxide is, for example, In₂O₃. The titanium oxide is, for example, TiO₂, and the tin oxide is, for example, SnO₂. The ratio between metal atoms and oxygen atoms in each of the metal oxides may deviate from the stoichiometric ratio. The ZnO content, In₂O₃ content, TiO₂ content, and SnO₂ content of the first metal oxide layer 12 to the four components may be the same as those of the second metal oxide layer 14.

The first metal oxide layer 12 may have higher resistance than the second metal oxide layer 14. Accordingly, the tin oxide content of the first metal oxide layer 12 may be lower than that of the second metal oxide layer 14, and the first metal oxide layer 12 may contain no tin oxide.

When the second metal oxide layer 14 contains three components of zinc oxide, indium oxide, and titanium oxide, it is preferable that the ZnO content to the total of the three components as the three components are converted to ZnO, In₂O₃, and TiO₂ be the highest among the contents of the three components. From the viewpoint of sufficiently increasing the total light transmittance, the ZnO content to the total of the three components is, for example, 45 mol % or higher. From the viewpoint of sufficiently increasing the storage stability, the ZnO content of the second metal oxide layer 14 to the total of the three components is, for example, 85 mol % or lower.

From the viewpoint of sufficiently increasing the total light transmittance, the In₂O₃ content of the first metal oxide layer 12 to the total of the three components is, for example, 35 mol % or lower. From the viewpoint of sufficiently increasing the corrosion resistance, the In₂O₃ content of the first metal oxide layer 12 to the total of the three components is, for example, 10 mol % or higher.

From the viewpoint of sufficiently increasing the total light transmittance, the TiO₂ content of the first metal oxide layer 12 to the total of the three components is, for example, 20 mol % or lower. From the viewpoint of sufficiently increasing the corrosion resistance, the TiO₂ content of the first metal oxide layer 12 to the total of the three components is, for example, 5 mol % or higher.

The thicknesses of the first metal oxide layer 12 and the second metal oxide layer 14 may be each, for example, 19 to 71 nm, or 20 to 60 nm, or 30 to 50 nm. With such thicknesses, high total light transmittance and superior productivity can be achieved in combination.

It is preferable from the viewpoint of antenna gain that the surface resistivity of the transparent conductive film 10 be low. The surface resistivity of the transparent conductive film 10 can be adjusted by changing the thickness of the first metal oxide layer 12. It is preferable from the viewpoint of sufficiently reducing the surface resistivity with high total light transmittance maintained that the thickness of the first metal oxide layer 12 be 24 to 50 nm.

The first metal oxide layer 12 and the second metal oxide layer 14 can be formed by using any of vacuum film formation methods such as vacuum deposition methods, sputtering methods, ion plating methods, and CVD methods. Among these, sputtering methods are preferable in that they allow downsizing of a film-forming chamber and that the film-forming speed is high. Examples of sputtering methods include DC magnetron sputtering. For the target, an oxide target or a metal or metalloid target can be used.

As illustrated in FIGS. 1 and 2, the second metal oxide layer 14 is connected to the center pin 24a of the connector 24 with the paste 26. A high-frequency electromagnetic wave received by the element 20 is introduced to the connector 24 via the second metal oxide layer 14 and the metal layer 16. For this reason, it is preferable that the second metal oxide layer 14 have high conductivity. It is preferable that the surface resistivity measured on the surface of the second metal oxide layer 14 be, for example, 20 Ω/sq. or lower, it is more preferable that the surface resistivity be 10 Ω/sq. or lower, it is even more preferable that the surface resistivity be 8 Ω/sq. or lower, and it is particularly preferable that the surface resistivity be 3 Ω/sq. or lower. The surface resistivity is a value measured by using a four-terminal resistivity meter.

The metal layer 16 is a layer containing silver or a silver alloy as a primary component. With the high conductivity possessed by the metal layer 16, the surface resistivity of the transparent conductive film 10 can be sufficiently reduced. The metal elements constituting the silver alloy are Ag and, for example, at least one selected from the group consisting of Pd, Cu, Ge, Ga, Nd, In, Sn, and Sb. Examples of the silver alloy include Ag—Pd, Ag—Cu, Ag—Pd—Cu, Ag—Nd—Cu, Ag—In—Sn, and Ag—Sn—Sb.

The metal layer 16 may contain an additive in addition to the silver or silver alloy. It is preferable that the additive be readily removable with an acidic etching solution. The silver or silver allow content of the metal layer 16 may be, for example, 90% by mass or higher, or 95% by mass or higher. From the viewpoint of sufficiently reducing the surface resistivity and sufficiently increasing the total light transmittance of the transparent conductive film 10, the thickness of the metal layer 16 is preferably 5 to 30 nm, more preferably 10 to 30 nm, and even more preferably 10 to 20 nm. If the thickness of the metal layer 16 is excessively large, the total light transmittance is likely to be lower. If the thickness of the metal layer 16 is excessively small, on the other hand, the surface resistivity is likely to be higher.

The metal layer 16 has a function of adjusting the total light transmittance and surface resistivity of the transparent conductive film 10. The metal layer 16 can be formed by using any of vacuum film formation methods such as vacuum deposition methods, sputtering methods, ion plating methods, and CVD methods. Among these, sputtering methods are preferable in that they allow downsizing of a film-forming chamber and that the film-foaming speed is high. Examples of sputtering methods include DC magnetron sputtering. For the target, a metal target can be used.

As illustrated in FIG. 3, both edge portions of each of the first metal oxide layer 12, the second metal oxide layer 14, and the metal layer 16 have been removed through etching. Accordingly, the widths of the first metal oxide layer 12, the second metal oxide layer 14, and the metal layer 16 (the lengths in the horizontal direction in FIG. 3) are smaller than those of the transparent resin substrate 11, the first hard coat layer 18, and the second hard coat layer 19. Thus, the antenna gain, directivity, and so forth can be adjusted through etching. Specifically, the first metal oxide layer 12, the second metal oxide layer 14, and the metal layer 16 can be processed into a desired shape through etching in accordance with required antenna gain, directivity, and so on. For the etching solution, acidic one can be used. Examples of the acidic etching solution include PAN etching solution containing phosphoric acid, acetic acid, nitric acid, and hydrochloric acid, and iron chloride-based etching solution.

The transparent conductive film 10 includes: the first hard coat layer 18 on a main face of the transparent resin substrate 11 in the first metal oxide layer 12 side; and the second hard coat layer 19 on a main face of the transparent resin substrate 11 in the side opposite to the first metal oxide layer 12. The thickness, structure, and composition of the first hard coat layer 18 and those of the second hard coat layer 19 (hereinafter, occasionally referred to as “hard coat layers 18 and 19”, collectively) may be the same as or different from each other. It is not necessarily needed to include both the first hard coat layer 18 and the second hard coat layer 19, and only one of them may be included.

Generation of scratches in the transparent resin substrate 11 can be sufficiently prevented by providing the first hard coat layer 18 and/or the second hard coat layer 19. Each of the hard coat layers 18 and 19 contains a cured resin obtained by curing a resin composition. It is preferable that the resin composition contain at least one selected from thermosetting resin compositions, ultraviolet-curable resin compositions, and electron beam-curable resin compositions. As a thermosetting resin composition, at least one selected from epoxy resins, phenoxy resins, and melamine resins may be contained.

The resin composition is a composition containing a curable compound having an energy ray-reactive group such as a (meth)acryloyl group and a vinyl group. The expression “(meth)acryloyl group” is intended to include at least one of an acryloyl group and a methacryloyl group. It is preferable that the curable compound contain a polyfunctional monomer or oligomer having two or more, preferably, three or more energy ray-reactive groups in one molecule.

The curable compound preferably contains an acrylic monomer. Specific examples of the acrylic monomer include 1,6-hexanediol di(meth)acrylate, triethylene glycol di(meth)acrylate, ethylene oxide-modified bisphenol A di(meth)acrylate, trimethylolpropane tri(meth)acrylate, trimethylolpropane ethylene oxide-modified tri(meth)acrylate, trimethylolpropane propylene oxide-modified tri(meth)acrylate, pentaerythritol tetra(meth)acrylate, ditrimethylolpropane tetra(meth)acrylate, dipentaerythritol penta(meth)acrylate, dipentaerythritol hexa(meth)acrylate, pentaerythritol tri(meth)acrylate, and 3-(meth)acryloyloxy glycerin mono(meth)acrylate. However, the acrylic monomer is not necessarily limited to these. Further examples of the acrylic monomer are urethane-modified acrylate and epoxy-modified acrylate.

A compound having a vinyl group may be used as the curable compound. Examples of the compound having a vinyl group include ethylene glycol divinyl ether, pentaerythritol divinyl ether, 1,6-hexanediol divinyl ether, trimethylolpropane divinyl ether, ethylene oxide-modified hydroquinone divinyl ether, ethylene oxide-modified bisphenol A divinyl ether, pentaerythritol trivinyl ether, dipentaerythritol hexavinyl ether, and ditrimethylolpropane polyvinyl ether. However, the compound having a vinyl group is not necessarily limited to these.

When curable compound is cured with an ultraviolet ray, the resin composition contains a photopolymerization initiator. Various photopolymerization initiators can be used. For example, a photopolymerization initiator can be appropriately selected from known compounds including acetophenone-based, benzoin-based, benzophenone-based, and thioxanthone-based compounds. More specific examples include Darocur 1173, Irgacure 651, Irgacure 184, and Irgacure 907 (product names, all produced by Ciba Specialty Chemicals), and KAYACURE DETX-S (product name, produced by Nippon Kayaku Co., Ltd.).

It is preferred to contain the photopolymerization initiator with a content of about 0.01 to 20% by mass or 0.5 to 5% by mass to the mass of the curable compound. The resin composition may be a known product obtained by adding a photopolymerization initiator to an acrylic monomer. Examples of the product obtained by adding a photopolymerization initiator to an acrylic monomer include the ultraviolet-curable resin SD-318 (product name, produced by Dainippon Ink and Chemicals, Incorporated) and XNR5535 (product name, produced by NAGASE & CO., LTD.).

The resin composition may contain an organic fine particle and/or inorganic fine particle, for example, in order to increase the strength of the coating film and/or adjust the refractive index. Examples of the organic fine particle include organosilicon fine particles, crosslinked acrylic fine particles, and crosslinked polystyrene fine particles. Examples of the inorganic fine particle include silicon oxide fine particles, aluminum oxide fine particles, zirconium oxide fine particles, titanium oxide fine particles, and iron oxide fine particles. Among these, silicon oxide fine particles are preferable.

Also applicable is a fine particle such that the surface has been treated with a silane coupling agent and energy ray-reactive groups including a (meth)acryloyl group and/or a vinyl group are present as a film on the surface. If such a reactive fine particle is used, the film strength can be increased through interparticle reaction of the fine particle or reaction of the fine particle and the polyfunctional monomer or oligomer in energy ray irradiation. Preferably used is a silicon oxide fine particle treated with a silane coupling agent containing a (meth)acryloyl group.

From the viewpoint of ensuring sufficient transparency, the average particle size of the fine particle is smaller than the thicknesses of the hard coat layers 18 and 19, and may be 100 nm or smaller, or 20 nm or smaller. From the viewpoint of production of colloidal solution, the average particle size may be 5 nm or larger, or 10 nm or larger. In using an organic fine particle and/or inorganic fine particle, the total amount of the organic fine particle and inorganic fine particle may be, for example, 5 to 500 parts by mass, or 20 to 200 parts by mass, to 100 parts by mass of the curable compound.

If a resin composition curable with an energy ray is used, the resin composition can be cured by irradiation with an energy ray such as an ultraviolet ray. Accordingly, use of such a resin composition is preferable from the viewpoint of the production process.

The first hard coat layer 18 can be formed by applying a solution or dispersion of a resin composition to one surface of the transparent resin substrate 11 and drying the resultant to cure the resin composition. The application can be performed by using a known method. Examples of application methods include an extrusion nozzle method, a blade method, a knife method, a bar coating method, a kiss coating method, a kiss reverse method, a gravure roll method, a dipping method, a reverse roll method, a direct roll method, a curtain method, and a squeezing method. The second hard coat layer 19 can be produced in the same manner as for the first hard coat layer 18 on the other surface of the transparent resin substrate 11.

The thicknesses of the first hard coat layer 18 and the second hard coat layer 19 are each, for example, 0.5 to 10 μm. If the thickness is over 10 μm, unevenness of thickness and wrinkles or the like are likely to be generated. If the thickness is below 0.5 μm, on the other hand, when a substantial amount of low-molecular-weight components such as a plasticizer and oligomers is contained in the transparent resin substrate 11, it is difficult in some cases to sufficiently prevent the bleed-out of these components. It is preferable from the viewpoint of prevention of warping that the thickness of the first hard coat layer 18 and that of the second hard coat layer 19 be the same as or comparable to each other.

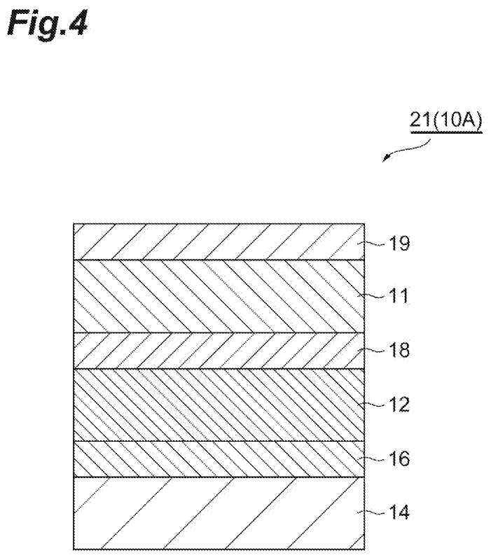

FIG. 4 shows a schematic cross-sectional view of the transparent conductive film for antennas constituting the ground section 21 illustrated in FIGS. 1 and 2. The direction of stacking in the transparent conductive film 10A in FIG. 4 corresponds to the vertical direction in FIG. 1. The transparent conductive film 10A is disposed in a manner such that the second metal oxide layer 14 and the supporting section 24b of the connector 24 contact with each other. Although the direction of stacking in the transparent conductive film 10A and the direction of stacking in the transparent conductive film 10 in FIG. 3 are opposite to each other, the composition, shape, and property of each layer of the transparent conductive film 10A may be the same as or similar to those of the corresponding layer of the transparent conductive film 10.

While the transparent conductive film 10A is different from the transparent conductive film 10 in that edge portions of each of the first metal oxide layer 12, the second metal oxide layer 14, and the metal layer 16 in the transparent conductive film 10A have not been etched in contrast to the transparent conductive film 10, the contents of description on the other parts of the transparent conductive film 10 are applied to the corresponding parts of the transparent conductive film 10A. In other embodiments, however, a part of each of the first metal oxide layer 12, the second metal oxide layer 14, and the metal layer 16 in the transparent conductive film 10A may have been removed through etching, similarly. In still other embodiments, only a part of each of the second metal oxide layer(s) 14 and the metal layer(s) 16 in the transparent conductive film 10 and/or the transparent conductive film 10A may have been removed through etching.

The transparent conductive film 10 constituting the element 20 and the transparent conductive film 10A constituting the ground section 21 may have the same layer configuration or different layer configurations.

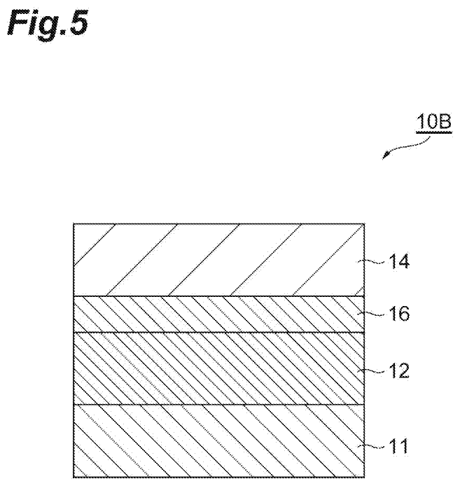

FIG. 5 shows a schematic cross-sectional view illustrating another embodiment of the transparent conductive film for antennas constituting the element 20 or the ground section 21. The transparent conductive film 10B in FIG. 5 is different from the transparent conductive films 10 and 10A in that the transparent conductive film 10B does not include the hard coat layers 18 and 19. The other configurations are identical to those of the transparent conductive film 10A. As with the case of the transparent conductive film 10, a part of each of the first metal oxide layer 12, the second metal oxide layer 14, and the metal layer 16 in the transparent conductive film 10B may have been removed through etching.

The thickness of each layer constituting the transparent conductive films 10, 10A, and 10B can be measured by using the following procedure: the transparent conductive film 10, 10A, or 10B is cut by using a focused ion beam (FIB) apparatus to obtain a cross-section thereof; and the cross-section is observed by using a transmission electron microscope (TEM) to measure the thickness of each layer. It is preferable to measure at 10 or more points arbitrarily selected and determine the mean value. Besides the focused ion beam apparatus, a microtome may be used as a method to obtain a cross-section. A scanning electron microscope (SEM) may be used as a method for measuring thicknesses. Alternatively, film thicknesses can be measured by using an X-ray fluorescence analyzer. The thicknesses of the transparent conductive films 10, 10A, and 10B may be each 200 μm or smaller, or 150 μm or smaller.

The transparent conductive films 10, 10A, and 10B including the above-described configurations have low surface resistivity and are superior in transparency and flexibility, and hence can be suitably used for an antenna. The antenna is not limited to monopole antennas as shown in FIGS. 1 and 2. Examples of other forms of antennas to which the transparent conductive films 10, 10A, and 10B are applied include dipole antennas, whip antennas, loop antennas, and slot antennas. Examples of uses of antennas to which the transparent conductive films 10, 10A, and 10B are applied include WiFi antennas, GPS antennas, digital terrestrial antennas, one-seg and full-seg antennas, RFID antennas, base station antennas for small cells, and radio antennas. However, the form and use of antennas are not limited to the above-described ones. The transparent conductive films 10, 10A, and 10B are available for low-frequency to high-frequency electromagnetic waves.

From another viewpoint, the above-described embodiments can be said to be application of a transparent conductive film to antennas, the transparent conductive film comprising: a transparent resin substrate; a first metal oxide layer; a metal layer containing a silver alloy; and a second metal oxide layer, stacked in this order. Each of the above-described transparent conductive films 10, 10A, and 10B can be used for such a transparent conductive film.

From still another viewpoint, the above-described embodiments can be said to be usage of the transparent conductive film 10, 10A, or 10B in antennas. Since the transparent conductive film 10, 10A, or 10B is used in the usage, antennas of various shapes can be formed.

Although some embodiments have been described hereinabove, the present disclosure is by no means limited to the embodiments. For example, use of the transparent conductive film for both an element and a ground section of an antenna is not essential, and the transparent conductive film may be used for only one of the element and ground section.

### EXAMPLES

The contents of the present invention will be described in more detail with reference to Examples and Comparative Example; however, the present invention is not limited to the following Examples.

[Fabrication of Antennas]

### Example 1

A monopole antenna as illustrated in FIG. 1 was fabricated. The transparent conductive film 10 used for the element 20 had the cross-sectional structure shown in FIG. 3. The transparent conductive film 10A used for the ground section 21 had the cross-sectional structure shown in FIG. 4. The transparent conductive films 10 and 10A were fabricated in the following procedure.

A polyethylene terephthalate film (produced by TORAY INDUSTRIES, INC., product number: U48) of 125 μm in thickness was prepared. This PET film was used as a transparent resin substrate. A coating material for forming the first hard coat layer and the second hard coat layer was prepared in the following procedure.

The following raw materials were prepared.
Colloidal silica modified with reactive group (dispersion medium: propylene glycol monomethyl ether acetate, nonvolatile content: 40% by mass): 100 parts by mass
Dipentaerythritol hexaacrylate: 48 parts by mass
1,6-Hexanediol diacrylate: 12 parts by mass
Photopolymerization initiator (1-hydroxycyclohexyl phenyl ketone): 2.5 parts by mass

These raw materials were diluted with a solvent (propylene glycol monomethyl ether (PGMA)) and mixed together to disperse the components in the solvent. Thereby, a coating material with a nonvolatile content (NV) of 25.5% by mass was prepared. The thus-obtained coating material was used as a coating material for forming the first hard coat layer 18 and the second hard coat layer 19.

The coating material for forming the first hard coat layer 18 and the second hard coat layer 19 was applied to one surface of the transparent resin substrate 11 to form a coating film. The solvent in the coating film was removed in a hot-air drying furnace set to 80° C., and then the coating film was irradiated with an ultraviolet ray with a cumulative dose of 400 MJ/cm² by using a UV treatment apparatus to cure the coating film. Thus, the first hard coat layer 18 of 2 μm in thickness was formed on one surface of the transparent resin substrate 11. Similarly, the second hard coat layer 19 of 2 μm in thickness was formed on the other surface of the transparent resin substrate 11.

The first metal oxide layer 12, the metal layer 16, and the second metal oxide layer 14 were sequentially formed above the first hard coat layer 18 through DC magnetron sputtering. The first metal oxide layer 12 was formed by using a ZnO—In₂O₃—TiO₂ target. The second metal oxide layer 14 was formed by using a ZnO—In₂O₃—TiO₂—SnO₂ target. The compositions of the first metal oxide layer and the second metal oxide layer were as shown in Table 1 (unit: mol %). The thicknesses of the first metal oxide layer and the second metal oxide layer in each Example were each 40 nm.

TABLE 1

| | ZnO | In₂O₃ | TiO₂ | SnO₂ |
|---|---|---|---|---|
| Second metal oxide layer | 35 | 29 | 14 | 22 |
| First metal oxide layer | 77 | 14 | 9 | 0 |

The metal layer 16 was formed by using an Ag—Pd—Cu target. The composition of the metal layer 16 was Ag:Pd:Cu=99.0:0.5:0.5 (% by mass). The thickness of the metal layer 16 was 13.9 nm.

After the first metal oxide layer 12, the metal layer 16, and the second metal oxide layer 14 were formed for the transparent conductive film 10A as described above, the transparent conductive film 10A was processed into the shape of the ground section 21 shown in FIGS. 1 and 2. The external shape of the transparent conductive film 10A obtained by the processing was a rectangle of L=150 mm, and included a through-hole (1=5 mm) in the center portion. This transparent conductive film 10A was used as the ground section 21.

After the first hard coat layer 18, the second hard coat layer 19, the first metal oxide layer 12, the metal layer 16, and the second metal oxide layer 14 were formed for the transparent conductive film 10 as described above, the transparent conductive film 10 was etched by soaking, with a part thereof masked, in a PAN etching solution containing phosphoric acid, acetic acid, nitric acid, and hydrochloric acid at room temperature for 1 minute. Thus, a part of each of the first metal oxide layer 12, the second metal oxide layer 14, and the metal layer 16 was etched to afford the transparent conductive film 10 having the cross-sectional shape as illustrated in FIG. 3. This transparent conductive film 10 was used as the element 20.

The transparent conductive film 10 was pasted on the supporting substrate 28 made of foamed polystyrene, and one end of the transparent conductive film 10 and the center pin 24a of the connector 24 were connected to each other with the paste 26 (silver paste) commercially available. Thus, a monopole antenna of Example 1 as illustrated in

FIGS. 1 and 2 was fabricated. The length and width of the transparent conductive film 10 were 30 mm and 2 mm, respectively. The height of the upper end of the element 20 from the ground section 21 (element length) was 36 mm.

### Comparative Example 1

A monopole antenna of Comparative Example 1 was fabricated in the same manner as in Example 1, except that a copper round bar (ϕ): 1.6 mm) was used in place of the transparent conductive film 10 and a copper foil was used in place of the transparent conductive film 10A. The element length in Comparative Example 1 was 33 mm.

[Evaluation of Antennas]

### <Evaluation on VSWR and Radiation Efficiency>

A cable was connected to the connector 24 of each antenna fabricated to measure the VSWR (voltage standing wave ratio) and radiation efficiency. VSWRs were measured by using an analyzer produced by Agilent Technologies (product name: E5061B (5 Hz-3 GHz) ENA Network Analyzer). Measurement results were as shown in Table 2. In Table 2, frequencies at which a minimum VSWR was given and VSWR values at the frequencies are shown.

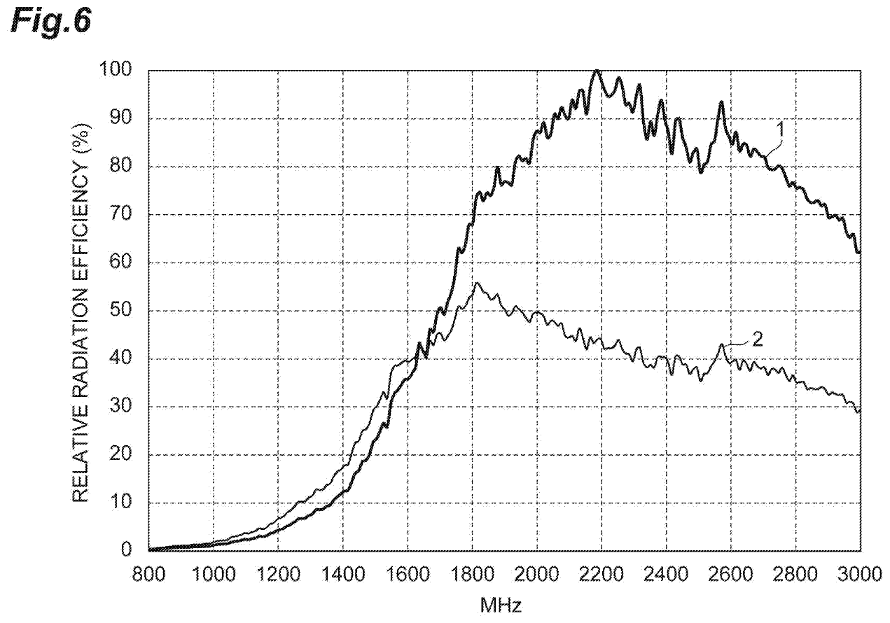

Radiation efficiencies were measured by using an analyzer produced by SATIMO (product name: StarLab 18 GHz). FIG. 6 shows a graph of measurement data converted to relative radiation efficiencies as the maximum value of radiation efficiency for Comparative Example 1 was assumed as 100%. In FIG. 6, the wavy line “1” shows data for Comparative Example 1 and the wavy line “2” shows data for Example 1. In Table 2, frequencies at which a maximum relative radiation efficiency was given, and measurements of radiation efficiency and values of relative radiation efficiency at the frequencies are shown.

TABLE 2

| | | | Comparative |
|---|---|---|---|
| Item | Unit | Example 1 | Example 1 |
| Element width/Element diameter | mm | 2 | Φ1.6 |
| Element length | mm | 36 | 33 |
| Estimated applicable frequency | GHz | 2.08 | 2.27 |
| Frequency | GHz | 1.90 | 2.16 |
| VSWR (minimum value) | | 1.3 | 1.4 |
| Frequency | GHz | 1.81 | 2.19 |
| Radiation efficiency (measurement) | % | 47.4 | 85.0 |
| Relative radiation efficiency | % | 55.78 | 100 |

In Table 2, element lengths are each the height of the upper end of the transparent conductive film 10 from the ground section 21. Estimated applicable frequencies are each a value calculated on the basis of element length. As demonstrated in Table 2 and FIG. 6, the antenna of Example 1 was found to have superior antenna performance.

### Examples 2 to 6

Transparent conductive films 10 for the element 20 were fabricated, the transparent conductive films 10 differing from that of Example 1 in thickness. Thicknesses of the metal layer 16 in Examples were as shown in Table 3. Configurations except the thickness of the metal layer 16 were identical to those of the transparent conductive film of Example 1.

<Evaluation on Total Light Transmittance>

Total light transmittance (transmittance) and haze were measured for the transparent conductive films 10 of Examples by using a haze meter (product name: NDH-7000, produced by NIPPON DENSHOKU INDUSTRIES CO., LTD.). Measurement results are shown in Table 3.

### <Measurement of Surface Resistivity>

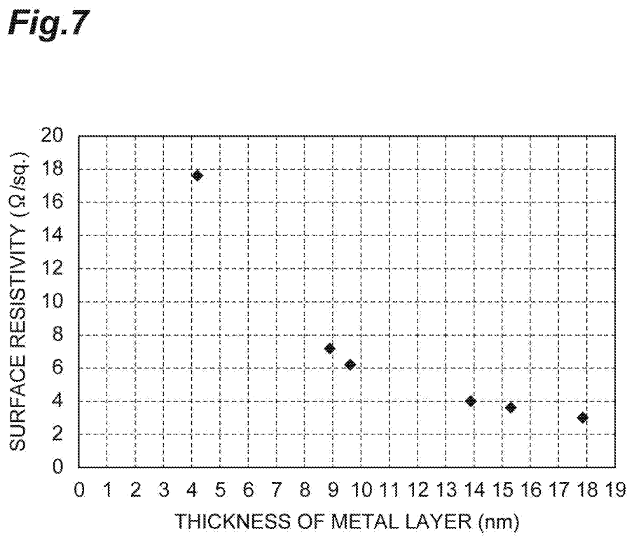

Surface resistivity (surface resistivity on the surface of the second metal oxide layer 14) was measured for the transparent conductive films 10 of Examples by using a four-terminal resistivity meter (product name: Loresta GP, produced by Mitsubishi Chemical Corporation). Measurement results are shown in Table 3 and FIG. 7.

TABLE 3

| | Thickness of | Surface | | |
|---|---|---|---|---|
| Example | metal layer | resistivity | Total light | |
| No. | (nm) | (Ω/sq.) | transmittance % | Haze % |
| Example 2 | 4.2 | 17.6 | 86.1 | 0.6 |
| Example 3 | 8.9 | 7.2 | 87.3 | 0.4 |
| Example 4 | 9.6 | 6.2 | 87.9 | 0.4 |
| Example 1 | 13.9 | 4.0 | 85.1 | 0.5 |
| Example 5 | 15.3 | 3.6 | 82.5 | 0.6 |
| Example 6 | 17.9 | 3.0 | 78.3 | 0.7 |

As demonstrated in Table 3 and FIG. 7, it was found that the surface resistivity can be sufficiently decreased by increasing the thickness of the metal layer 16. By setting the thickness of the metal layer 16 to 10 to 16 nm, a total light transmittance of approximately 80% or higher can be achieved with the surface resistivity lowered.

### Examples 7 to 19

Transparent conductive films 10 for the element 20 were fabricated, the transparent conductive films 10 differing from those of Examples 2 to 6 in thickness of at least one of the first hard coat layer 18, the second hard coat layer 19, the first metal oxide layer 12, the metal layer 16, and the second metal oxide layer 14. Thicknesses of the first metal oxide layer 12, the metal layer 16, and the second metal oxide layer 14 in Examples were as shown in Table 4. The thicknesses of the first hard coat layer 18 and the second hard coat layer 19 were each 1.5 μm. The transparent conductive films were fabricated in the same manner as in Examples 2 to 6 except those thicknesses. Then, total light transmittance and surface resistivity were measured in the same manner as in Examples 2 to 6. Measurement results are shown in Table 4.

TABLE 4

| | Thickness (nm) | | | | |
|---|---|---|---|---|---|
| | | First metal | Second | Surface | Total light |
| | Metal | oxide | metal | resistivity | transmittance |
| | layer | layer | oxide layer | (Ω/sq.) | (%) |
| Example 7 | 25 | 40 | 40 | 2.2 | 65.0 |
| Example 8 | 15 | 40 | 40 | 4.4 | 83.0 |
| Example 9 | 10 | 40 | 40 | 7.7 | 87.8 |
| Example 10 | 25 | 40 | 20 | 2.4 | 54.9 |
| Example 11 | 25 | 40 | 64 | 2.3 | 50.0 |
| Example 12 | 25 | 24 | 40 | 2.5 | 62.4 |
| Example 13 | 25 | 34 | 40 | 2.3 | 65.0 |
| Example 14 | 25 | 43 | 40 | 2.2 | 65.0 |
| Example 15 | 25 | 49 | 40 | 2.1 | 63.5 |
| Example 16 | 9 | 40 | 40 | 8.9 | 88.1 |
| Example 17 | 30 | 40 | 40 | 1.7 | 42.1 |
| Example 18 | 25 | 19 | 40 | 2.9 | 59.5 |
| Example 19 | 25 | 71 | 40 | 2.6 | 57.1 |

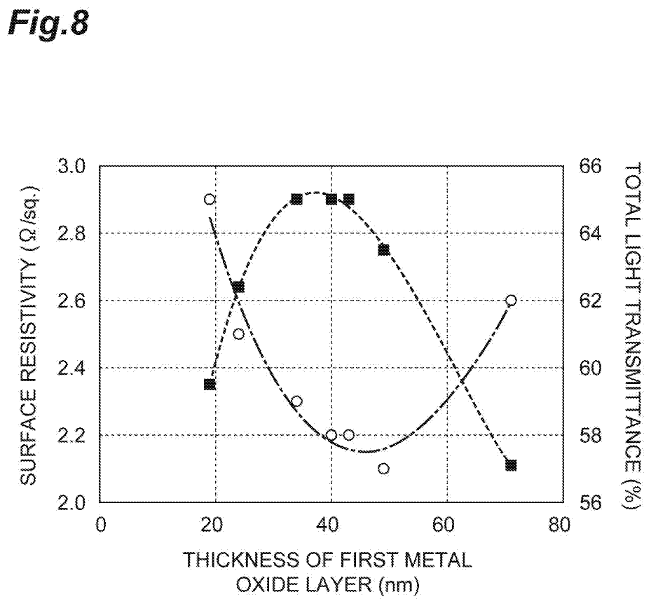

Among Examples 7 to 19, results for Examples 7, 12 to 15, 18, and 19, which were common in that the thickness of the metal layer was 25 nm and the thickness of the second metal oxide layer was 40 nm, are plotted in FIG. 8.

FIG. 8 shows a graph of relation between the thickness of the first metal oxide layer, and the surface resistivity and the total light transmittance. In FIG. 8, open circles plotted indicate surface resistivities, and filled squares plotted indicate total light transmittances. From these results, it was found that the surface resistivity and total light transmittance can be controlled by controlling the thickness of the first metal oxide layer. In particular, it was found that the surface resistivity can be sufficiently reduced with the high total light transmittance maintained by setting the thickness of the first metal oxide layer to 24 to 50 nm.

The transparent conductive film fabricated in Example 7 was etched in the same procedure as in Example 1 to afford the transparent conductive film 10 having the cross-sectional shape as illustrated in FIG. 3. This transparent conductive film 10 was used as the element 20 to fabricate a monopole antenna as illustrated in FIGS. 1 and 2 in the same procedure as in Example 1. The antenna was evaluated in the same manner as in Example 1. Evaluation results are shown in Table 5. The relative radiation efficiency is a relative value as the radiation efficiency for Comparative Example 1 was assumed as 100%.

TABLE 5

| Item | Unit | Example 7 |
|---|---|---|
| Element width/Element diameter | mm | 2 |
| Element length | mm | 36 |
| Estimated applicable frequency | GHz | 2.08 |
| Frequency | GHz | 1.90 |
| VSWR (minimum value) | | 1.1 |
| Frequency | GHz | 1.82 |
| Radiation efficiency (measurement) | % | 82.29 |
| Relative radiation efficiency | % | 96.81 |

In Table 5, the element length is the height of the transparent conductive film 10 from the ground section 21. The estimated applicable frequency is a value calculated on the basis of element length. As demonstrated in Table 5, the antenna of Example 7 was also found to have superior antenna performance.

### INDUSTRIAL APPLICABILITY

According to the present disclosure, a transparent conductive film for antennas is provided which enables formation of antennas having superior transparency and superior antenna performance in combination. In addition, a transparent conductive film capable of sufficiently reducing the surface resistivity with the total light transmittance kept high is provided.

### REFERENCE SIGNS LIST

10, 10A, 10B: Transparent conductive film, 11: transparent resin substrate, 12: first metal oxide layer, 14: second metal oxide layer, 16: metal layer, 18: first hard coat layer, 19: second hard coat layer, 20: element, 21: ground section, 22: through-hole, 24: connector, 24a: Center pin, 24b: supporting section, 26: paste, 28: supporting substrate, 100: antenna.

1. A transparent conductive film for antennas, comprising:
a transparent resin substrate;
a first metal oxide layer;
a metal layer containing silver or a silver alloy; and
a second metal oxide layer,
stacked in this order.

2. The transparent conductive film for antennas according to claim 1, wherein a total light transmittance of the transparent conductive film is 50% or higher.

3. The transparent conductive film for antennas according to claim 1, wherein a surface resistivity of the transparent conductive film is 20 Ω/sq. or lower.

4. The transparent conductive film for antennas according to claim 1, wherein in an antenna fabricated from the transparent conductive film, a VSWR is 2.0 or lower when an element length thereof is set to 30 mm.

5. The transparent conductive film for antennas according to claim 1, wherein
thicknesses of the first metal oxide layer and the second metal oxide layer are each 20 to 60 nm, and
a thickness of the metal layer is 5 to 30 nm.

6. The transparent conductive film for antennas according to claim 1, wherein at least the metal layer and the second metal oxide layer are etched with an acidic etching solution.

7. The transparent conductive film for antennas according to claim 1, wherein a surface resistivity of the transparent conductive film is 8 Ω/sq. or lower.

8. The transparent conductive film for antennas according to claim 1, wherein a thickness of the first metal oxide layer is 24 to 50 nm.

9. The transparent conductive film for antennas according to claim 2, wherein a surface resistivity of the transparent conductive film is 20 Ω/sq. or lower.

10. The transparent conductive film for antennas according to claim 2, wherein in an antenna fabricated from the transparent conductive film, a VSWR is 2.0 or lower when an element length thereof is set to 30 mm.

11. The transparent conductive film for antennas according to claim 3, wherein in an antenna fabricated from the transparent conductive film, a VSWR is 2.0 or lower when an element length thereof is set to 30 mm.

12. The transparent conductive film for antennas according to claim 2, wherein
thicknesses of the first metal oxide layer and the second metal oxide layer are each 20 to 60 nm, and
a thickness of the metal layer is 5 to 30 nm.

13. The transparent conductive film for antennas according to claim 3, wherein
thicknesses of the first metal oxide layer and the second metal oxide layer are each 20 to 60 nm, and
a thickness of the metal layer is 5 to 30 nm.

14. The transparent conductive film for antennas according to claim 4, wherein
thicknesses of the first metal oxide layer and the second metal oxide layer are each 20 to 60 nm, and
a thickness of the metal layer is 5 to 30 nm.

15. The transparent conductive film for antennas according to claim 2, wherein at least the metal layer and the second metal oxide layer are etched with an acidic etching solution.

16. The transparent conductive film for antennas according to claim 3, wherein at least the metal layer and the second metal oxide layer are etched with an acidic etching solution.

17. The transparent conductive film for antennas according to claim 4, wherein at least the metal layer and the second metal oxide layer are etched with an acidic etching solution.

18. The transparent conductive film for antennas according to claim 5, wherein at least the metal layer and the second metal oxide layer are etched with an acidic etching solution.
